(19) United States
(12) Patent Application Publication
(10) Pub. No.: US 2017/0107959 A1
(43) Pub. Date: Apr. 20, 2017

(54) FUEL SUPPLY CONTROL DEVICE

(71) Applicants: AISAN KOGYO KABUSHIKI KAISHA, Obu-shi (JP); TOYOTA JIDOSHA KABUSHIKI KAISHA, Toyota-shi (JP)

(72) Inventors: Mutsumi TSUJINO, Nagoya-shi (JP); Akito UCHIDA, Toyota-shi (JP)

(73) Assignees: AISAN KOGYO KABUSHIKI KAISHA, Obu-shi (JP); TOYOTA JIDOSHA KABUSHIKI KAISHA, Toyota-shi (JP)

(21) Appl. No.: 15/290,608

(22) Filed: Oct. 11, 2016

(30) Foreign Application Priority Data
Oct. 15, 2015 (JP) 2015-204001

(51) Int. Cl. F02M 53/04; F02M 63/00

(52) U.S. Cl. CPC F02M 53/04; F02M 63/007; F02M 2200/07

(57) ABSTRACT

A control device, which is a fuel supply control device, performs a self-heating procedure by which an electric current is applied to a solenoid of a CNG injection valve in such a range that CNG is not injected from the CNG injection valve before engine operation using CNG is started.

### BACKGROUND OF THE INVENTION

The present invention relates to a fuel supply control device that controls an injection valve that supplies gas fuel to an internal combustion engine.

As described in Japanese Laid-Open Patent Publication No. 2000-282955, a fuel supply control device that supplies gas fuel such as CNG (Compressed Natural Gas) to an internal combustion engine has a fuel tank, which retains gas fuel maintained at a high pressure. The gas fuel, which is retained in the fuel tank, contains the oil mist that has been mixed with the gas fuel at the time of compression of the gas fuel to a high pressure. When the gas fuel is injected from an injection valve, the oil contained in the gas fuel adheres to the injection valve. At an extremely low temperature, such as an outside air temperature of “0° C.” or lower, viscosity of the oil adhering to the injection valve increases and the oil solidifies. This causes insufficient opening of the injection valve, or, in other words, fixation of the injection valve.

The control device determines whether the injection valve is fixed at the start of engine operation using the gas fuel. If the injection valve is fixed, the control device increases the time for energizing the injection valve. The injection valve has a solenoid. By energizing the solenoid, the injection valve is caused to self-heat. Therefore, an increased energizing time of the injection valve increases the self-heating amount of the injection valve. This heats the injection valve and the oil adhering to the injection valve. The viscosity of the oil is thus decreased and fixation of the injection valve is canceled. As a result, the injection valve is allowed to inject the gas fuel and engine operation using the gas fuel is started.

The control device determines whether the injection valve is fixed before the start of the engine operation using gas fuel, or, in other words, based on the outside air temperature at the time the engine is stopped. Therefore, a low outside air temperature may cause the control device to determine that the injection valve is fixed, despite the fact that the injection valve is not actually fixed, and to increase the energizing time of the injection valve. In this case, the injection amount of the gas fuel from the injection valve may be excessively great compared to the requested injection amount.

If the injection valve is actually fixed, the time from when energization of the injection valve is started to when fixation of the injection valve is canceled and injection of the gas fuel is actually started is not constant. That is, the time for which the gas fuel is actually injected from the injection valve varies, thus varying the injection amount of the gas fuel from the injection valve. As a result, the operating state at the start of the engine operation using the gas fuel tends to be unstable.

### SUMMARY OF THE INVENTION

Accordingly, it is an objective of the present invention to provide a fuel supply control device capable of canceling fixation of an injection valve and stabilizing the operating state at the start of engine operation using gas fuel.

To solve the above-described problem, according to a first aspect of the present invention, a fuel supply control device includes a control section that performs a self-heating procedure by which an electric current is applied to a solenoid of an injection valve in such a range that gas fuel is not injected from the injection valve before engine operation using the gas fuel is started.

### BRIEF DESCRIPTION OF THE DRAWINGS

FIG. 1 is a schematic diagram representing a control device, which is a first embodiment of a fuel supply control device according to the present invention, and an internal combustion engine operation of which is controlled by the control device.

FIG. 2 is a cross-sectional view showing a CNG injection valve adapted to inject CNG,

FIG. 3 is a timing chart representing temperature change of the CNG injection valve caused by self-heating.

FIG. 4 is a map with reference to which the performing time of a self-heating procedure is set based on the delivery temperature in a CNG delivery pipe.

FIG. 5 is a timing chart representing variation of an electric current flowing in a solenoid of the CNG injection valve at the time of the self-heating procedure.

FIG. 6 is a flowchart representing a procedure routine executed in engine operation using gasoline.

FIG. 7 is a flowchart representing a procedure routine executed by a fuel supply control device of a second embodiment.

FIG. 8 is a timing chart representing variation of voltage applied to a solenoid of a CNG injection valve when a self-heating procedure is performed by a fuel supply control device of another example.

FIG. 9 is a timing chart representing variation of an electric current flowing in a solenoid of a CNG injection valve when a self-heating procedure is performed by a fuel supply control device of another example.

### DETAILED DESCRIPTION OF THE PREFERRED EMBODIMENTS

### First Embodiment

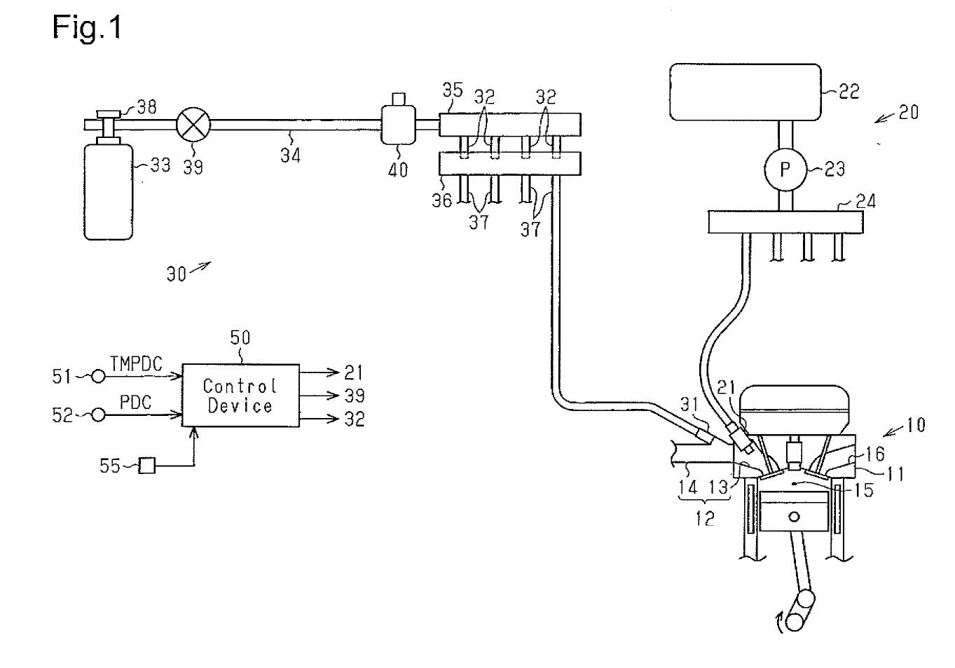

A first embodiment of a fuel supply control device according to the present invention will now be described with reference to FIGS. 1 to 6.

FIG. 1 represents a control device 50, which is a fuel supply control device, and an internal combustion engine 10, operation of which is controlled by the control device 50. The engine 10 is a bi-fuel type internal combustion engine capable of selecting between operation using gasoline, which is an example of liquid fuel, and operation using CNG (Compressed Natural Gas), which is an example of gas fuel.

With reference to FIG. 1, the engine 10 has a cylinder head 11 in which an intake port 13, or a portion of an intake passage 12, is arranged. The intake port 13 is connected to an intake manifold 14, which is another portion of the intake passage 12. Gasoline injection valves 21, which inject gasoline into the intake port 13, are attached to the cylinder head 11. A cylindrical fuel injection tube 31 is attached to the intake manifold 14. The fuel injection tube 31 is coupled to CNG injection valves 32, which inject CNG.

To supply CNG to the engine 10, the CNG is injected from the CNG injection valves 32 and then flows into the intake manifold 14 through the fuel injection tube 31.

In the engine 10, air-fuel mixture containing fuel (gasoline or CNG), which is supplied through opening/closing of the gasoline injection valves 21 or the CNG injection valves 32, and intake air is generated in the intake passage 12. The air-fuel mixture is drawn into a combustion chamber 15 of the engine 10. The air-fuel mixture is then burned in the combustion chamber 15. Combustion gas (exhaust gas), which is produced through combustion, is then discharged from the combustion chamber 15 into an exhaust passage 16.

The engine 10 includes a gasoline supply system 20, which supplies gasoline as fuel, and a CNG supply system 30, which supplies CNG as fuel. The CNG supply system 30 configures an example of “a fuel supply device” that supplies CNG to the combustion chamber 15.

The gasoline supply system 20 includes a fuel pump 23, which draws gasoline from a gasoline tank 22 and delivers the gasoline under pressure, and a gasoline delivery pipe 24 into which the fuel delivered from the fuel pump 23 under pressure flows. The gasoline injection valves 21, which are provided by the number equal to the number of the cylinders of the engine 10 (four in the example shown in FIG. 1), are connected to the gasoline delivery pipe 24. The gasoline injection valves 21 are each attached to the corresponding one of the four cylinders, or, specifically, the intake port 13 of the corresponding cylinder.

The CNG supply system 30 includes a high-pressure fuel line 34 and a CNG delivery pipe 35. The high-pressure fuel line 34 is connected to a CNG tank 33, which retains high-pressure CNG. The CNG delivery pipe 35 is connected to a downstream end section (the right end section as viewed in FIG. 1) of the high-pressure fuel line 34 in the fuel flow direction. The CNG injection valves 32, which are provided by the number equal to the number of the cylinders of the engine 10, are connected to the CNG delivery pipe 35. A cover 36 is fixed to the CNG delivery pipe 35 using a bolt. The CNG injection valves 32 are arranged between the cover 36 and the CNG delivery pipe 35 and spaced apart at regular intervals.

Fuel hoses 37 are connected to the cover 36. In the CNG supply system 30, an injecting portion of each of the CNG injection valves 32 communicates with the corresponding one of the fuel hoses 37 through a through hole formed in the interior of the cover 36. A downstream end section of each of the fuel hoses 37 is connected to the fuel injection tube 31. When each CNG injection valve 32 is opened and closed, the CNG in the CNG delivery pipe 35 passes through the interior of the cover 36 and the corresponding fuel hose 37 and flows into the intake manifold 14 through the fuel injection tube 31.

The CNG supply system 30 has a manual open/close valve 38, which is a manually operated type open/close valve, between the CNG tank 33 and the high-pressure fuel line 34. The high-pressure fuel line 34 has a shutoff valve 39, which is selectively opened and closed through control by the control device 50, at a downstream side of the manual open/close valve 38. When the manual open/close valve 38 and the shutoff valve 39 are both open, flow of CNG from the CNG tank 33 into the high-pressure fuel line 34 is permitted. In contrast, if at least either the manual open/close valve 38 or the shutoff valve 39 is closed, the flow of CNG from the CNG tank 33 into the high-pressure fuel line 34 is prohibited.

The high-pressure fuel line 34 also has a regulator 40, which depressurizes the CNG supplied from the CNG tank 33, at a downstream side of the shutoff valve 39. After having been depressurized to a certain pressure by the regulator 40, the CNG is supplied to the CNG delivery pipe 35.

A temperature sensor 51, a fuel pressure sensor 52, and a switch 55 are electrically connected to the control device 50. The temperature sensor 51 detects a delivery temperature TMPDC, which is the temperature in the CNG delivery pipe 35. The fuel pressure sensor 52 detects a delivery fuel pressure PDC, which is the pressure in the CNG delivery pipe 35. The switch 55 is manipulated by an occupant of the vehicle to switch from engine operation using gasoline to engine operation using CNG. In the engine operation using gasoline, the control device 50 controls opening/closing of the gasoline injection valves 21. In the engine operation using CNG, the control device 50 controls opening/closing of the CNG injection valves 32 with the shutoff valve 39 held in an open state.

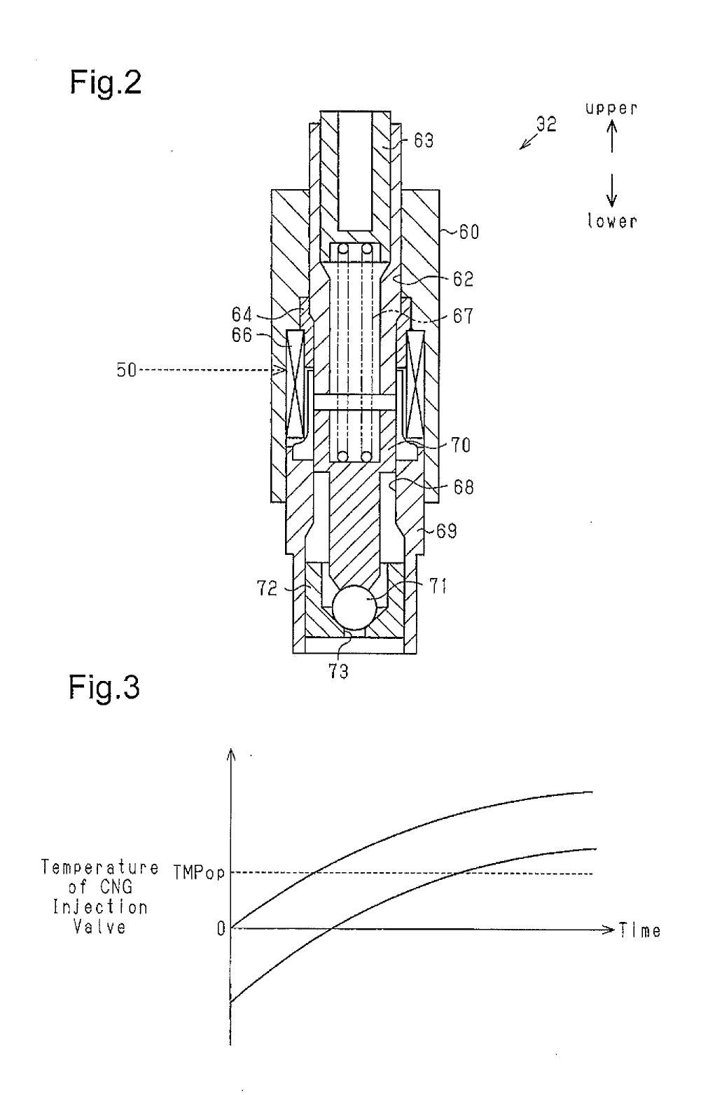

The CNG injection valves 32 will hereafter be described with reference to FIG. 2. In the description below, the upward and downward directions are defined as represented in FIG. 2.

As shown in FIG. 2, each of the CNG injection valves 32 is a normally closed type electromagnetic valve. Each CNG injection valve 32 includes a substantially cylindrical body housing 60 having a through hole 62. A closing member 63 is attached to an upper end of the body housing 60 to close an upper end of the through hole 62. A bobbin 64 and a solenoid 66, which is wound around the outer periphery of the bobbin 64, are arranged at a middle position in the through hole 62.

A spring 67, which is supported by the closing member 63, is arranged at an inner peripheral side of the bobbin 64. The spring 67 is selectively extended and compressed in the axial direction of the body housing 60.

A valve body 69 is attached to a lower end of the body housing 60. An upper end of the valve body 69 is arranged in the through hole 62 of the body housing 60. A lower end of the valve body 69 is arranged outside the body housing 60.

The valve body 69 has an accommodation hole 68, which accommodates a movable iron core 70 in an axially slidable manner. The movable iron core 70 is constantly urged downward by the spring 67. When electric power is supplied to the solenoid 66, the electromagnetic power produced by the solenoid 66 slides the movable iron core 70 upward against the urging force of the spring 67.

A valve body 71 and a valve seat 72 are arranged inside the valve body 69. The valve body 71 is capable of sliding integrally with the movable iron core 70. The valve seat 72 closes a lower opening of the accommodation hole 68 and has an injection port 73. Without energization of the solenoid 66, the valve body 71 closes the injection port 73 of the valve seat 72. With the energization of the solenoid 66, the electromagnetic force produced by the solenoid 66 moves the valve body 71 upward, together with the movable iron core 70, thus separating the valve body 71 from the valve seat 72 to open the injection port 73. In this manner, the CNG that has been supplied into the CNG injection valve 32 through a non-illustrated inlet port is injected from the injection port 73.

The CNG supplied from the CNG supply system 30 contains oil mist. The oil contained in the CNG adheres to the valve body 71 and the valve seat 72, which are components of each

CNG injection valve 32. Afterwards, as the oil adhering to the valve body 71 and the valve seat 72 cools down, viscosity of the oil increases and the oil solidifies. This hampers separation of the valve body 71 from the valve seat 72 even when the solenoid 66 is energized. This state, in which separation of the valve body 71 from the valve seat 72 is hampered, is referred to as “fixation of the CNG injection valve 32”.

In the present embodiment, when the switch 55 is manipulated by a vehicle occupant to request switch from engine operation using gasoline to engine operation using CNG, the control device 50 performs a self-heating procedure by which an electric current is applied to the solenoid 66 of each CNG injection valve 32. The self-heating procedure is carried out when the engine operation using gasoline is performed and before the engine operation using CNG is started. In the self-heating procedure, the mode of energization is adjusted not to open the CNG injection valves 32. Therefore, by performing the self-heating procedure, each CNG injection valve 32 is caused to self-heat without injecting CNG from the CNG injection valve 32. This heats the CNG injection valve 32, thus heating the oil adhering to the CNG injection valve 32. As a result, the viscosity of the oil decreases and separation of the valve body 71 from the valve seat 72 is facilitated.

Referring to FIG. 3, there is a certain level of correlation between the viscosity of the oil and the temperature of the CNG injection valve 32 to which the oil adheres. That is, if the temperature of the CNG injection valve 32 is higher than or equal to a reference fixation temperature TMPop, it is determined that the viscosity of the oil is sufficiently low and that fixation of the CNG injection valve 32 does not occur. Therefore, the lower the temperature of the CNG injection valve 32 is before the CNG injection valve 32 is caused to self-heat, the greater the time needed to reach a determination that fixation of the CNG injection valve 32 has been canceled. That is, it is preferable to set a performing time TMC of the self-heating procedure to a greater value as the assumed temperature of the CNG injection valve 32 before the self-heating procedure becomes lower.

The control device 50 obtains the delivery temperature TMPDC in the CNG delivery pipe 35 as a parameter correlated with the temperature of the CNG injection valve 32. The control device 50 then sets the performing time TMC of the self-heating procedure based on the delivery temperature TMPDC. That is, the performing time TMC of the self-heating procedure is set to a greater value as the delivery temperature TMPDC before the self-heating procedure becomes lower.

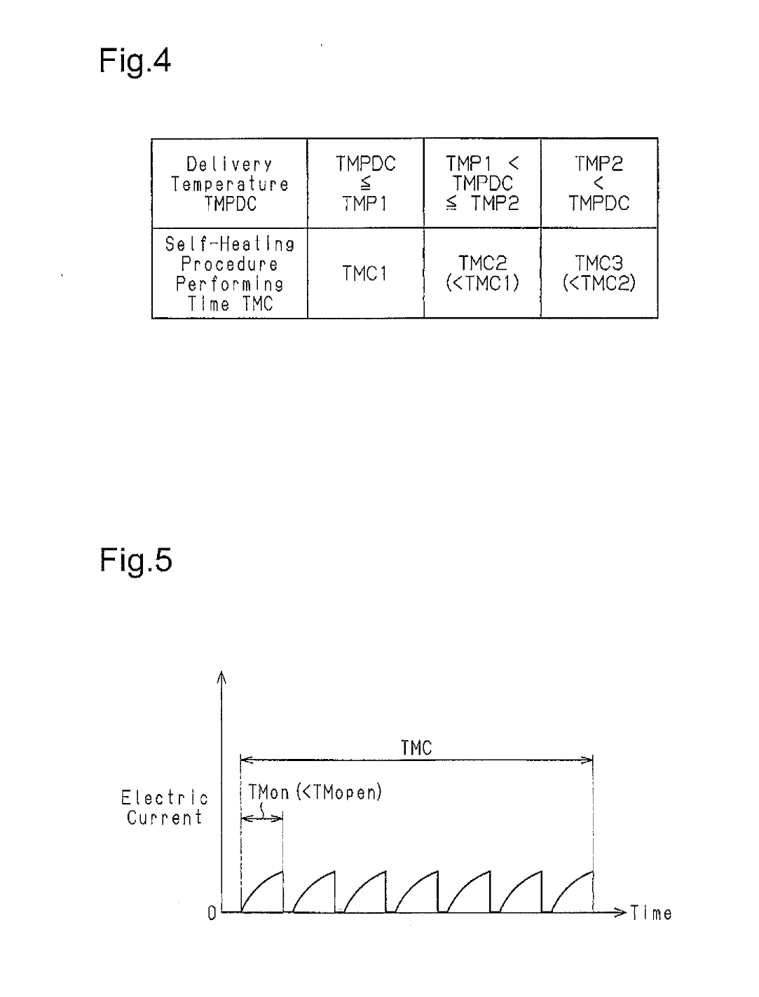

FIG. 4 represents an example of a map with reference to which the performing time TMC of the self-heating procedure is set based on the delivery temperature TMPDC. In the map of FIG. 4, a first temperature TMP1 is lower than a second temperature TMP2 and the second temperature TMP2 is lower than the aforementioned reference fixation temperature TMPop.

With reference to FIG. 4, when the delivery temperature TMPDC is lower than or equal to the first temperature TMP1, the performing time TMC is set to a first time TMC1. When the delivery temperature TMPDC is higher than the first temperature TMP1 and lower than or equal to the second temperature TMP2, the performing time TMC is set to a second time TMC2, which is smaller than the first time TMC1. When the delivery time TMPDC is higher than the second temperature TMP2, the performing time TMC is set to a third time TMC3, which is smaller than the second time TMC2.

The self-heating procedure performed by the control device 50 will hereafter be described with reference to FIG. 5.

The self-heating procedure is basically the same as control of the electric current supplied to the CNG injection valves 32 at the time CNG is injected from the CNG injection valves 32. However, an energizing time TMon needed for a single cycle of energization of the solenoid 66 of each CNG injection valve 32 is smaller than the energizing time of the solenoid 66 for injecting CNG from the CNG injection valve 32. That is, through energization of the solenoid 66, the electromagnetic force produced by the solenoid 66 becomes gradually greater. Then, when the electromagnetic force produced by the solenoid 66 is great such that the valve body 71 is separated from the valve seat 72, the CNG injection valves 32 become open to inject CNG.

In a circumstance in which the CNG injection valves 32 are free from foreign matter such as oil and thus non-fixed, a necessary valve-opening time TMopen from when energization of the solenoid 66 is started to when CNG injection from the CNG injection valves 32 is started is determined in advance using data about the CNG injection valves 32. That is, when the energizing time TMon of the solenoid 66 is less than the necessary valve-opening time TMopen, the CNG injection valves 32 are caused to self-heat but not opened regardless of whether the CNG injection valves 32 are fixed.

Therefore, as shown in FIG. 5, in the self-heating procedure, energization of the solenoid 66 for an energizing time TMon that is less than the necessary valve-opening time TMopen is repeated intermittently. Such intermittent energization continues throughout the performing time TMC. That is, the solenoid 66 is energized in such a range that CNG is not injected from the CNG injection valves 32.

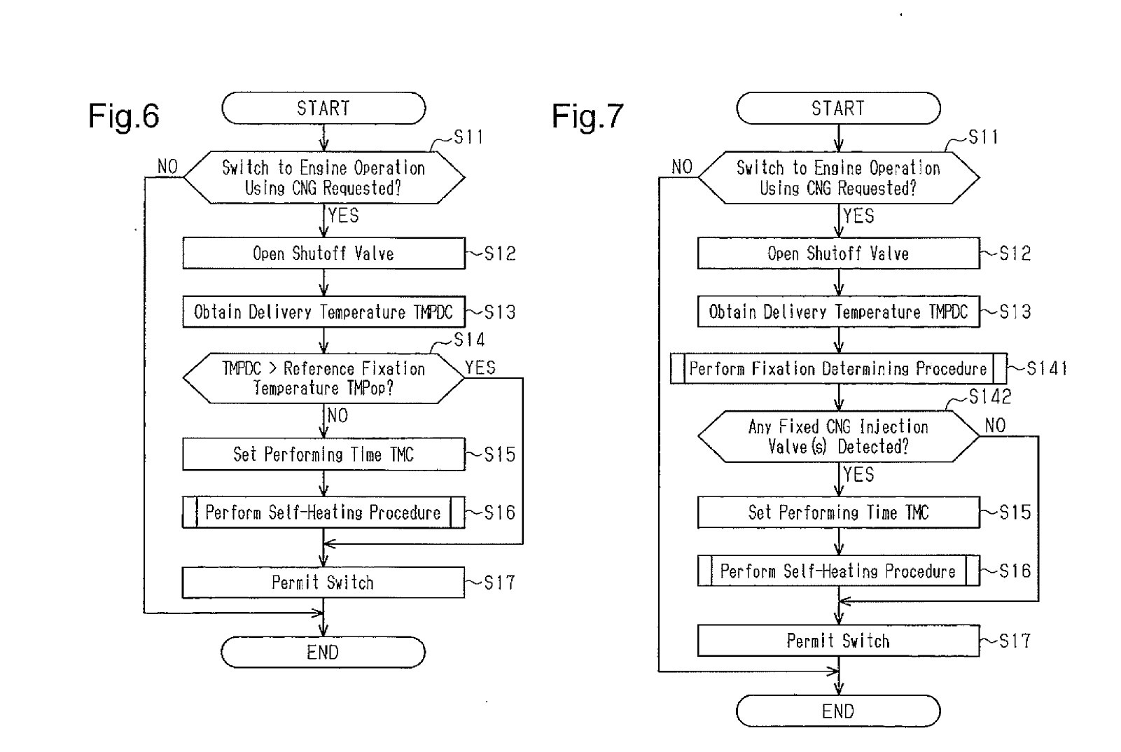

A procedure routine executed by the control device 50 in engine operation using gasoline will hereafter be described with reference to the flowchart of FIG. 6. The procedure routine is executed for each of the control cycles set in advance.

Referring to FIG. 6, the control device 50 determines whether switch to engine operation using CNG is requested (Step S11). That is, when manipulation of the switch 55 is detected in the engine operation using gasoline, the control device 50 determines that the switch to the engine operation using CNG is requested. If such switch is not requested (Step S11: NO), the control device 50 suspends the procedure routine.

In contrast, when the switch is requested (Step S11: YES), the control device 50 opens the shutoff valve 39 of the CNG supply system 30 (Step S12). Subsequently, the control device 50 obtains the delivery temperature TMPDC in the CNG delivery pipe 35 that has been detected by the temperature sensor 51 (Step S13). The control device 50 then determines whether the obtained delivery temperature TMPDC is higher than the aforementioned reference fixation temperature TMPop (Step S14). If the delivery temperature TMPDC is higher than the reference fixation temperature TMPop, the control device 50 determines that the CNG injection valves 32 are non-fixed.

In contrast, if the delivery temperature TMPDC is lower than or equal to the reference fixation temperature TMPop, the control device 50 determines that it is likely that the CNG injection valves 32 are fixed. In this regard, the control device 50 configures an example of “a determining section” that determines whether the CNG injection ,valves 32 are fixed.

Therefore, when the delivery temperature TMPDC is higher than the reference fixation temperature TMPop (Step S14: YES), the control device 50 carries out Step S17 of the procedure, which will be described later, without performing the self-heating procedure. In contrast, when the delivery temperature TMPDC is lower than or equal to the reference fixation temperature TMPop (Step S14: NO), the control device 50 sets the performing time TMC of the self-heating procedure to a value corresponding to the delivery temperature TMPDC with reference to the map of FIG. 4 (Step S15). In this regard, the control device 50 configures an example of “a time setting section” that obtains the delivery temperature TMPDC, which is correlated with the temperature of each CNG injection valve 32, and sets the performing time TMC of the self-heating procedure to a greater value as the temperature of the CNG injection valve 32 that is assumed based on the delivery temperature TMPDC becomes lower.

Next, the control device 50 performs the self-heating procedure for the set performing time TMC (Step S16). In this regard, the control device 50 configures an example of “a control section” that performs the self-heating procedure by which an electric current is applied to the solenoid 66 of each CNG injection valve 32 in such a range that CNG is not injected from the CNG injection valves 32 before the engine operation using CNG is started. After completing the self-heating procedure, the control device 50 carries out the subsequent step, which is Step S17.

In Step S17, the control device 50 permits the switch from the engine operation using gasoline to the engine operation using CNG. The control device 50 then suspends the procedure routine.

Operation at the time of the switch from the engine operation using gasoline to the engine operation using CNG will hereafter be described.

When the switch 55 is manipulated in the engine operation using gasoline (Step S11: YES), preparation of CNG supply by the CNG supply system 30 is carried out. That is, the shutoff valve 39 is opened (Step S12) and CNG is supplied into the CNG delivery pipe 35. If, in this state, the delivery temperature TMPDC is lower than or equal to the reference fixation temperature TMPop (Step S14: NO), the self-heating procedure is performed and the solenoid 66 of each CNG injection valve 32 is energized (Step S16).

After completion of the self-heating procedure, the switch to the engine operation using CNG is permitted (Step S17). Gasoline injection from the gasoline injection valves 21 is then prohibited and CNG is injected from the CNG injection valves 32. In this manner, the switch to the engine operation using CNG is completed.

The first embodiment has the advantages described below.

(1) The self-heating procedure by which the CNG injection valves 32 are heated without being opened is performed before the engine operation using CNG is started. Therefore, the engine operation using gasoline is switched to the engine operation using CNG after fixation of the CNG injection valves 32 is canceled. This restrains, at the start of the engine operation using CNG, variation of the time for which CNG is actually injected from the CNG injection valves 32 in the energizing time of the CNG injection valves 32. That is, at the start of the engine operation using CNG, variation of the CNG injection amount of the CNG injection valves 32 is restrained. This cancels fixation of the CNG injection valves 32 and stabilizes the operating state at the start of the engine operation using CNG.

(2) In the self-heating procedure, energization of the solenoid 66 of each CNG injection valve 32 for the energizing time TMon that is less than the necessary valve-opening time TMopen is repeated intermittently. As a result, the CNG injection valves 32 are caused to self-heat without injecting CNG from the CNG injection valves 32. This cancels fixation of the CNG injection valves 32 without influencing the operating state of the engine 10 using gasoline.

(3) The lower the temperature of each CNG injection valve 32 is assumed to be, the higher the viscosity of the foreign matter such as the oil adhering to the CNG injection valve 32 is assumed to be. Therefore, the performing time TMC of the self-heating procedure is set to a greater value as the assumed temperature of the CNG injection valve 32 becomes lower. This increases the temperature increase amount of each CNG injection valve 32 caused by the self-heating procedure, thus facilitating cancelation of fixation of the CNG injection valves 32.

When fixation of the CNG injection valves 32 is canceled comparatively easily, the performing time TMC of the self-heating procedure is set to a small value. In this case, the performing time TMC does not become unnecessarily great, thus ensuring early start of the engine operation using CNG. Also, the power consumption amount needed to cancel fixation of the CNG injection valves 32 is reduced.

(4) When it is determined that the CNG injection valves 32 are non-fixed and that the self-heating procedure is unnecessary, the engine operation using CNG is started without performing the self-heating procedure. This ensures early switch from the engine operation using gasoline to the engine operation using CNG. Also, the power consumption amount of the CNG injection valves 32 is reduced.

### Second Embodiment

A second embodiment of the fuel supply control device will hereafter be described with reference to FIG. 7. The second embodiment is different from the first embodiment in that the CNG injection valves 32 are checked for fixation independently from one another and that the self-heating procedure is performed only on those of the CNG injection valves 32 in which fixation is detected. The description is thus focused on the difference between the second embodiment and the first embodiment. Also, the same or similar reference numerals are given to components of the second embodiment that are the same as or similar to corresponding components of the first embodiment. Repeated description of the first embodiment is thus omitted herein.

In the second embodiment, the control device 50 performs a fixation determining procedure in engine operation using gasoline. That is, in the fixation determining procedure, one of all of the cylinders is defined as a target cylinder and CNG is supplied to the target cylinder as a test with gasoline supplied to the other cylinders than the target cylinder. In this case, if the CNG injection valve 32 of the target cylinder is non-fixed, CNG is injected from the CNG injection valve 32 through energization of the CNG injection valve 32. The delivery fuel pressure PDC, which is the pressure in the delivery pipe 35, is thus decreased. In contrast, if the CNG injection valve 32 of the target cylinder is fixed, CNG injection from the CNG injection valve 32 does not occur or occurs only by a slight CNG injection amount despite energization of the CNG injection valve 32. As a result, the delivery fuel pressure PDC is maintained unchanged or changed only by a slight change amount. In this manner, through test energization of the CNG injection valve 32 of the target cylinder, a determination is made as to whether the CNG injection valve 32 is fixed.

When determination as to fixation of one of the CNG injection valves 32 is completed, another one of the cylinders is selected as a target cylinder and CNG is supplied to the target cylinder as a test with gasoline supplied to the other cylinders than the target cylinder. After the above-described determination as to fixation is performed on all of the CNG injection valves 32, the fixation determining procedure is completed. The fixation determining procedure is carried out on one of the cylinders (in other words, the CNG injection valves 32) in each one of the cycles of the engine 10.

Next, a procedure routine executed by the control device 50 in the engine operation using gasoline will be described with reference to the flowchart of FIG. 7. The procedure routine is executed for each of the control cycles set in advance.

With reference to FIG. 7, when the switch to the engine operation using CNG is not requested (Step S11: NO), the control device 50 suspends the procedure routine. In contrast, when the switch to the engine operation using CNG is requested (Step S11: YES), the control device 50 opens the shutoff valve 39 of the CNG supply system 30 (Step S12) and obtains the delivery temperature TMPDC in the CNG delivery pipe 35 (Step S13).

The control device 50 then performs the above-described determination as to fixation on every one of the CNG injection valves 32 consecutively (Step S141). After performing the determination as to fixation on all of the CNG injection valves 32, the control device 50 determines whether a fixed one (fixed ones), if any, of the CNG injection valve 32 has (have) been detected (Step S142). In this regard, the control device 50 configures an example of “a fixation detecting section” that detects any fixed one(s) of the CNG injection valves 32 when the switch from the engine operation using gasoline to the engine operation using CNG is requested.

If no fixed one is detected in the CNG injection valves (Step S142: NO), the control device 50 carries out Step S17 of the procedure, which will be described later, without performing the self-heating procedure. In contrast, if any fixed one(s) is (are) detected in the CNG injection valves 32 (Step S142: YES), the control device 50 sets the performing time TMC of the self-heating procedure to a value corresponding to the obtained delivery temperature TMPDC with reference to the map of FIG. 4 (Step S15).

The control device 50 then performs the self-heating procedure for the set performing time TMC (Step S16). At this time, the control device 50 performs the self-heating procedure on the fixed one(s) of the CNG injection valves 32 and not on the non-fixed one(s) of the CNG injection valves 32. After completing the self-heating procedure, the control device 50 carries out the subsequent step of the procedure, which is Step S17.

In Step S17, the control device 50 permits the switch from the engine operation using gasoline to the engine operation using CNG. Then, the control device 50 suspends the procedure routine.

The second embodiment has the advantages described below, in addition to the same advantages as the advantages (1) to (4) of the first embodiment.

(5) The fixation determining procedure determines whether any of the CNG injection valves 32 are actually fixed. The self-heating procedure is performed on the fixed one(s) of the CNG injection valves 32 but not on the non-fixed one(s) of the CNG injection valves 32. This decreases the number of the CNG injection valves 32 that are subjected to the self-heating procedure, compared to a case in which the self-heating procedure is performed on all of the CNG injection valves 32 when fixation is detected in at least one of the CNG injection valves 32. As a result, the power consumption amount for canceling fixation of the CNG injection valves 32 is reduced.

(6) If fixation is not detected in the CNG injection valves 32 by the fixation determining procedure, the self-heating procedure is not performed. This restrains execution of the self-heating procedure despite the fact that the CNG injection valves 32 are actually non-fixed, unlike the first embodiment. As a result, unnecessary execution of the self-heating procedure is restrained.

The illustrated embodiments may be modified to the forms described below.

As long as CNG is not injected from the CNG injection valves 32, the procedure by which the CNG injection valves 32 are caused to self-heat may be a procedure different from those of the illustrated embodiments.

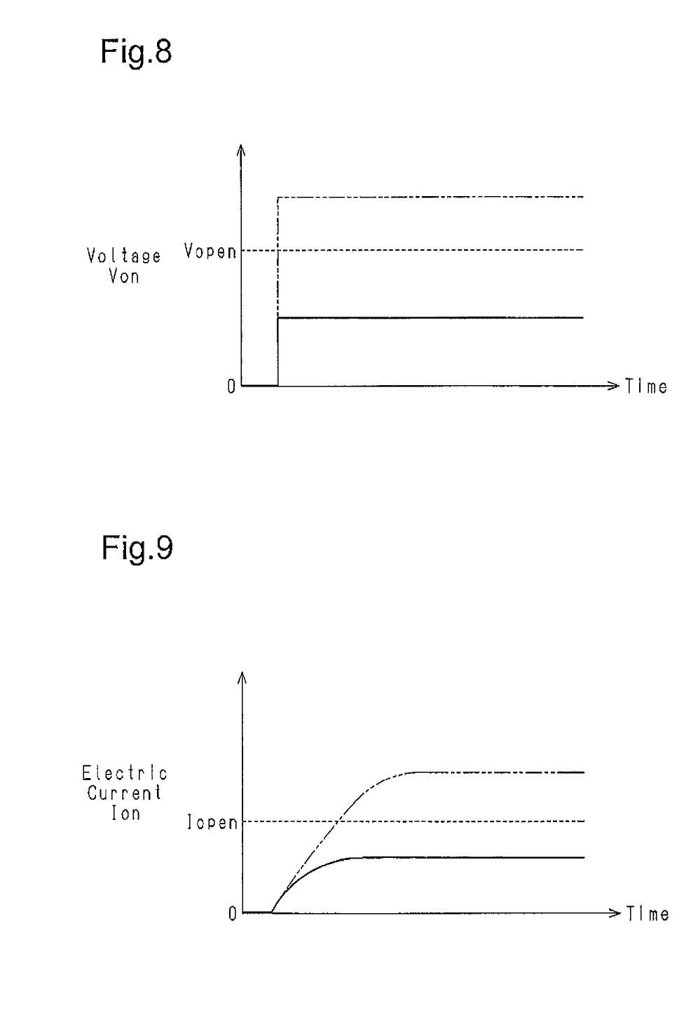

The long dashed double-short dashed line in FIG. 8 represents change of a voltage Von, which is applied to the solenoid 66 of the CNG injection valve 32, at the time each CNG injection valve 32 is opened with the voltage Von greater than or equal to a necessary valve-opening voltage Vopen in a circumstance in which the CNG injection valve 32 is non-fixed.

In this case, if the voltage Von is less than the necessary valve-opening voltage Vopen, the CNG injection valve 32 simply self-heats without opening, regardless of whether the CNG injection valve 32 is fixed. Therefore, as represented by the solid line in FIG. 8, the self-heating procedure may be performed by continuously applying the voltage Von smaller than the necessary valve-opening voltage Vopen to the solenoid 66 of the CNG injection valve 32. Also in this case, the CNG injection valve 32 is caused to self-heat without injecting CNG from the CNG injection valve 32. This cancels fixation of the CNG injection valve 32 without influencing the engine operation using gasoline. In this case, it is assumed that, the greater the voltage Von, the greater the self-heating amount of the CNG injection valve 32. Therefore, the self-heating procedure may be performed such that the voltage Von becomes greater in the range less than the necessary valve-opening voltage Vopen as the assumed temperature of the CNG injection valve 32 becomes lower. When, like this case, the voltage Von is varied in correspondence with the assumed temperature of the CNG injection valve 32, the performing time TMC of the self-heating procedure may be fixed.

The long dashed double-short dashed line in FIG. 9 represents change of an electric current Ion, which flows in the solenoid 66 of the CNG injection valve 32, at the time each CNG injection valve 32 is opened with the electric current Ion greater than or equal to a necessary valve-opening electric current Iopen in a circumstance in which the CNG injection valve 32 is non-fixed. In this case, if the electric current Ion is less than the necessary valve-opening electric current Iopen, the CNG injection valve 32 simply self-heats without opening, regardless of whether the CNG injection valve 32 is fixed. Therefore, as represented by the solid line in FIG. 9, the self-heating procedure may be performed by continuously applying the electric current Ion smaller than the necessary valve-opening electric current Iopen to the solenoid 66 of the CNG injection valve 32. Also in this case, the CNG injection valve 32 is caused to self-heat without injecting CNG from the CNG injection valve 32. This cancels fixation of the CNG injection valve 32 without influencing the engine operation using gasoline. In this case, it is assumed that, the greater the electric current Ion, the greater the self-heating amount of the CNG injection valve 32. Therefore, the self-heating procedure may be performed such that the electric current Ion becomes greater in the range less than the necessary valve-opening electric current Iopen as the assumed temperature of the CNG injection valve 32 becomes lower. When, like this case, the electric current Ion is varied in correspondence with the assumed temperature of the CNG injection valve 32, the performing time TMC of the self-heating procedure may be fixed.

In the second embodiment, after the fixation determining procedure, the self-heating procedure is performed on only the fixed one(s) of the CNG injection valves 32. Instead, if any one of the CNG injection valves 32 is fixed, the self-heating procedure may be performed on all of the CNG injection valves 32.

After the self-heating procedure, a procedure by which confirmation is made as to whether CNG can be injected from the CNG injection valves 32 may be carried out. Further, when it is confirmed that CNG can be injected from the CNG injection valves 32, the switch from the engine operation using gasoline to the engine operation using CNG may be permitted. Methods of performing such confirmation include the methods described below.

In the engine operation using gasoline, CNG is injected from the CNG injection valve 32 by such an amount that emission of exhaust gas is not influenced. If, as a result, change is detected in the oxygen concentration of the exhaust gas (the air-fuel ratio of the air-fuel mixture that has been burned in the cylinder) or the delivery fuel pressure PDC, it is determined that CNG can be injected from the CNG injection valves 32. Alternatively, CNG is supplied to one of the cylinders, which is a determination target, as a test through the corresponding one of the CNG injection valves 32, with gasoline supplied to the other ones of the cylinders. If, as a result, change is detected in the delivery fuel pressure PDC, it is determined that CNG can be injected from the CNG injection valve 32.

The lower the temperature of the environment in which the engine 10 is used, the more likely the viscosity of the oil adhering to any CNG injection valve 32 is to be great. Therefore, the performing time TMC of the self-heating procedure may be set to a greater value as the temperature of the environment in which the engine 10 is used becomes lower. In this case, the temperature of the environment in which the engine 10 is used corresponds to “a parameter correlated with the temperature of the CNG injection valve 32”. This configuration also ensures the same advantage as the advantage (3).

Each CNG injection valve 32 may be connected directly to the intake manifold 14. In this case, the temperature of the coolant of the engine 10 is correlated with the temperature of the CNG injection valve 32 to a higher extent than the delivery temperature TMPDC is correlated with the temperature of the CNG injection valve 32. Therefore, when each CNG injection valve 32 is connected directly to the intake manifold 14, the performing time TMC of the self-heating procedure may be set to a greater value as the temperature of the coolant of the engine 10 becomes lower. In this case, the temperature of the coolant of the engine 10 corresponds to “a parameter correlated with the temperature of the CNG injection valve 32”. This configuration also ensures the same advantage as the advantage (3).

The performing time TMC of the self-heating procedure may be a fixed value regardless of the temperature of the CNG injection valves 32. In this case, it is preferable to set the performing time TMC of the self-heating procedure in correspondence with the lowermost temperature at which the CNG injection valves 32 are expected to be used.

The self-heating procedure may be continued until immediately before the engine operation using CNG is actually started.

When the switch from the engine operation using gasoline to the engine operation using CNG is requested, the self-heating procedure may be performed on all of the CNG injection valves 32 without determining whether the CNG injection valves 32 are fixed.

The internal combustion engine including the CNG supply system 30 may be a mono-fuel type internal combustion engine that lacks the gasoline supply system 20. In this case, CNG supply to the combustion chambers of the engine continues since the start of the engine. Therefore, when the engine start is requested by the driver, the self-heating procedure is performed and then the engine operation is started.

The vehicle including the fuel supply control device may be embodied as a hybrid vehicle including a motor as a drive source, in addition to the internal combustion engine 10. In this case, if the engine operation using CNG is requested in a circumstance in which the vehicle runs through driving of the motor, the self-heating procedure is performed before the engine operation using CNG is started.

As long as the gas fuel is combustible by an internal combustion engine and is supplied to an injection valve as gas, the gas fuel may be any other suitable gas fuel than CNG. For example, if the gas fuel is hydrogen gas, gasoline may be employed as liquid fuel.

The gas fuel may be LPG (Liquefied Petroleum Gas). The LPG contains foreign matter such as tar and the tar in the LPG may adhere to an injection valve. Also, when the tar cools down, the viscosity of the tar increases and causes fixation of the injection valve. Therefore, also in this case, by performing the self-heating procedure to cause self-heating of the injection valve, the viscosity of the foreign matter such as the tar is decreased to cancel fixation of the injection valve.

1. A fuel supply control device employed in a fuel supply device that supplies a gas fuel into a combustion chamber of an internal combustion engine and has an injection valve that injects the gas fuel, wherein the fuel supply control device controls the injection valve, and the control device comprises a control section that performs a self-heating procedure by which an electric current is applied to a solenoid of the injection valve in such a range that the gas fuel is not injected from the injection valve before operation of the engine using the gas fuel is started.

2. The fuel supply control device according to claim 1, wherein
the injection valve is opened when, in a circumstance in which the injection valve is non-fixed, an energizing time of the solenoid of the injection valve reaches a necessary valve-opening time, and
the control section intermittently repeats energization for an energizing time of the solenoid that is less than the necessary valve-opening time through the self-heating procedure.

3. The fuel supply control device according to claim 1, wherein
the injection valve is opened when, in a circumstance in which the injection valve is non-fixed, a voltage applied to the solenoid of the injection valve is greater than or equal to a necessary valve-opening voltage, and
the control section continuously applies a voltage that is smaller than the necessary valve-opening voltage to the solenoid of the injection valve through the self-heating procedure.

4. The fuel supply control device according to claim 1, wherein
the injection valve is opened when, in a circumstance in which the injection valve is non-fixed, an electric current flowing in the solenoid of the injection valve is greater than or equal to a necessary valve-opening electric current, and
the control section continuously applies an electric current that is smaller than the necessary valve-opening electric current to the solenoid of the injection valve through the self-heating procedure.

5. The fuel supply control device according to claim 1, comprising a time setting section that obtains a parameter correlated with the temperature of the injection valve and sets a performing time of the self-heating procedure to a greater value as the temperature of the injection valve that is assumed based on the parameter becomes lower, wherein, before the operation of the engine using the gas fuel is started, the control section performs the self-heating procedure for the performing time that has been set by the time setting section.

6. The fuel supply control device according to claim 1, comprising a determining section that determines whether the injection valve is fixed, wherein, when the determining section does not determine that the injection valve is fixed, the control section does not perform the self-heating procedure.

7. The fuel supply control device according to claim 1, wherein
the internal combustion engine is a bi-fuel type internal combustion engine capable of selecting between operation using a liquid fuel and operation using the gas fuel,
the fuel supply control device includes a fixation detecting section that detects fixation in the injection valve when switch from the operation of the engine using the liquid fuel to the operation of the engine using the gas fuel is requested,
when, in a circumstance in which the switch is requested, the fixation detecting section detects the fixation in the injection valve, the control section performs the self-heating procedure on the fixed injection valve, and
after performing the self-heating procedure, the control section switches from the operation of the engine using the liquid fuel to the operation of the engine using the gas fuel.

8. The fuel supply control device according to claim 1, wherein
the internal combustion engine is a bi-fuel type internal combustion engine capable of selecting between operation using a liquid fuel and operation using the gas fuel,
when switch from the operation using the liquid fuel to the operation using the gas fuel is requested, the control section performs the self-heating procedure, and
after performing the self-heating procedure, the control section switches from the operation of the engine using the liquid fuel to the operation of the engine using the gas fuel.
